(19) United States
(12) Patent Application Publication
(10) Pub. No.: US 2004/0012166 A1
(43) Pub. Date: Jan. 22, 2004

(54) Scooter assembly

(76) Inventor: Robert Reginato, Reservoir (AU)

Correspondence Address: MORRISON & FOERSTER LLP, 3811 VALLEY CENTRE DRIVE, SUITE 500, SAN DIEGO, CA, 92130-2332, US

(21) Appl. No.: 10/450,486

(22) PCT Filed: Dec. 14, 2000
(86) PCT No.: PCT/AU00/01538

(51) Int. Cl. B62M 1/00

(52) U.S. Cl. 280/87.041

(57) ABSTRACT

This invention relates to a scooter assembly comprising a frame; a kickboard mounted relative to said frame; a front wheel assembly including a front wheel which is rotatably mounted relative to said frame to facilitate steering of the scooter; and a rear wheel assembly, wherein said rear wheel assembly comprises at least one pair of wheels which are mounted relative to said frame for pivotal movement in a lateral plane relative to the plane of said kickboard.

The present invention relates to a scooter assembly. More particularly, the invention relates to a scooter assembly which is designed to combine advantageous features of a scooter and a skateboard to provide a new form of conveyance.

Scooters having a kickboard and front and rear wheels are known. Such conveyances generally include relatively small wheels, the front of which is steerable to effect steering of the scooter. Further steering may be provided by titling the scooter to either side as desired. Notwithstanding this is however, scooters will generally not provide any substantial steering control on weight transfer of the rider on the kickboard of the scooter.

Australian Patent Application No. AU-A-12261/97 describes a wheeled conveyance which is akin to a scooter in that it includes a kickboard mounted on a frame disposed between front and rear wheels The front wheels include two inline skate wheels mounted on a rotatable steering column, while the rear wheels include a pair of small wheels mounted on an axle which is pivotally mounted relative to the kickboard. The rear wheels are mounted such that the pivotal action is in a plane which is parallel to the plane of the kickboard. This is said to provide improved steering capabilities to the wheeled conveyance insofar as transfer of weight of a rider effects a pivotal motion of the rear wheels which in turn provides for improved steerage of the conveyance. The conveyance according to this Australian application, however, is relatively unstable as compared with conventional scooters. Moreover, it has been found that the pivotal action of the rear wheels, although possibly improving manoeuvrability, reduces the stability of the conveyance.

The present invention aims to provide an alternative scooter assembly which overcomes the stability problems associated with the prior art assemblies, but which maintains the advantageous manoeuvrability aspects thereof.

According to the present invention, therefore, there is provided a scooter assembly comprising:

a frame;

a kickboard mounted relative to said frame;

a front wheel assembly including a front wheel which is rotatably mounted relative to said frame to facilitate steering of the scooter assembly; and

a rear wheel assembly, wherein said rear wheel assembly comprises at least one pair of wheels which are mounted relative to said frame for pivotal movement in a lateral plane relative to the plane of said kickboard.

The rear wheel assembly includes rear wheels which are mounted for lateral pivotal movement relative to the plane of the kickboard. In a preferred embodiment, the rear wheel assembly comprises a conventional skateboard truck assembly including an axle housing which houses a hanger, yoke, base-plate and center pivot, substantially the entirety of the skateboard truck being located underneath the kickboard. It will be understood that the rear wheel assembly may include additional pairs of wheels provided that these are pivotal in-like manner to that described above.

The front wheel assembly includes a front wheel which is rotatably mounted relative to the frame. In a preferred embodiment, the front wheel assembly comprises a conventional bicycle handlebar arrangement including handlebars, a goose-neck and steering column which passes through a yoke, a pair of forks connected to the steering column and a front wheel mounted on the forks. In a preferred embodiment, the front wheel is an oversized wheel, such as a small bike wheel or conventional scooter wheel. More preferably, the front wheel includes a spoked wheel and a pneumatic tyre.

The frame itself and kickboard may take any suitable form. In a preferred embodiment, however, the frame includes a lower portion on which the kickboard is mounted, and an upper curved portion which is rigidly fixed to the lower portion to provide stability to the assembly as a whole. It will be recognised that the form of the frame may be altered depending on the final desired form of the scooter assembly. For example, if the kickboard to be used is relatively narrow, then the lower portion of the frame may include a single portion of tubing which passes centrally under the kickboard to which the kickboard is attached. Alternatively, if the kickboard is of oversized width, such as that provided in a conventional skateboard, then the lower portion of the frame may include a pair of substantially parallel tubes which pass under the kickboard and are attached thereto and which are rigidly attached to a portion of the front wheel assembly.

The kickboard, as mentioned in the immediately preceding paragraph, may take any suitable form. In a preferred embodiment, the kickboard is an oversized board as seen on conventional skateboards. This includes a flat front portion for a rider's front foot and an upwardly curved rear portion for a rider's rear foot. As is the case with a conventional skateboard, the upward curved rear portion of the kickboard provides leverage for the rider when the scooter assembly is in use.

Due to the pivotal action of the rear wheel assembly, the kickboard may in use tilt from side to side on the transfer of weight of the rider. This in combination with the front wheel assembly, which provides for pivotal steerage of the scooter assembly as a whole, advantageously provides substantially improved manoeuvrability of the assembly. Further, the provision of the kickboard advantageously facilitates additional manoeuvres for the performance of tricks or the like. Further to this, the assembly as described above is advantageously extremely stable in use.

A preferred embodiment of the scooter assembly will now be described in detail with reference to the accompanying drawings in which:

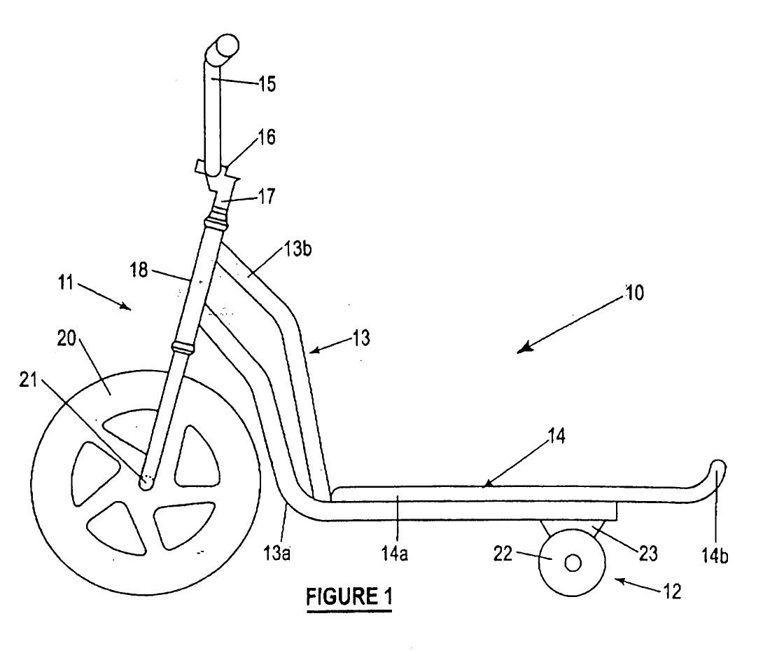

FIG. 1 illustrates a side view of the scooter assembly;

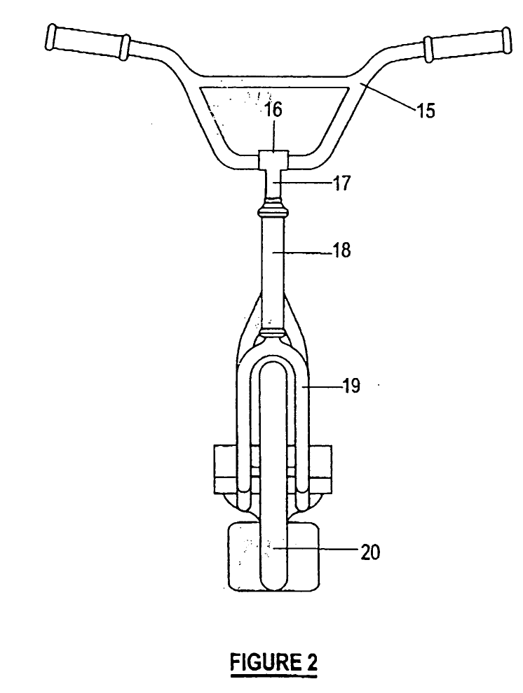

FIG. 2 illustrates a front view of the scooter assembly; and

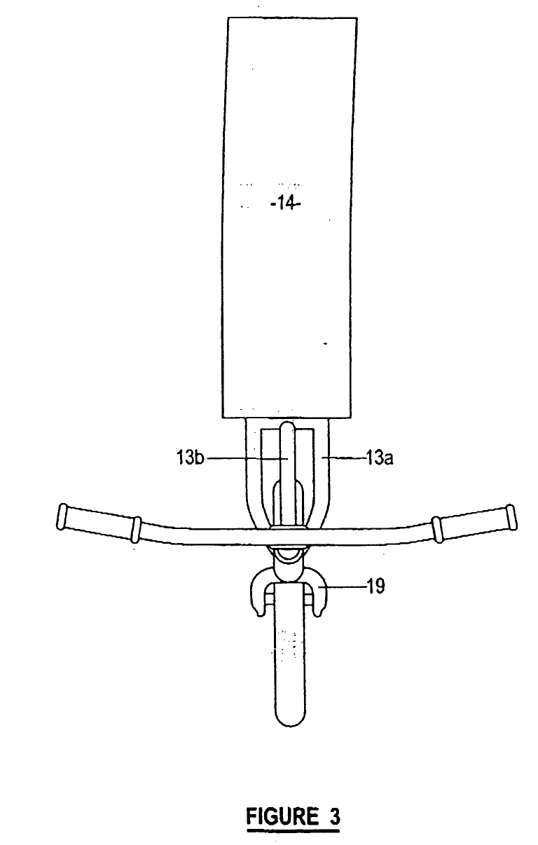

FIG. 3 illustrates a plan view of the scooter assembly.

### DESCRIPTION OF THE DRAWINGS

Referring to the Figures, the scooter assembly 10 includes a front wheel assembly 11, a rear wheel assembly 12, a frame 13 and a kickboard 14.

The front wheel assembly 11 includes a pair of handle bars 15 which are akin to conventional bicycle handle bars, which pass through a goose-neck 16 which is in turn attached to a steering column 17. The steering column 17 passes through a yoke 18 and is rotatably mounted relative to the yoke 18. At the base of the yoke 18, the steering column 17 is attached to a pair of front forks 19 on which is mounted a front wheel 20 by means of an axle 21. The front wheel 20 is advantageously a spoked wheel which includes a pneumatic tyre. The provision of a pneumatic tyre advantageously provides a comfortable ride to a user of the scooter assembly 10 and provides good grip to a road surface or the like on which the scooter assembly 10 is being ridden.

The rear wheel assembly 12 comprises a conventional skateboard truck assembly. This comprises a pair of wheels 22 and an under carriage 23 relative to which the rear wheels 22 are axially and pivotally mounted. The pivot of the rear wheels is in a plane which is vertical to the plane of the kickboard 14 of the assembly. That is, referring to FIG. 1, the wheels 22 of the rear wheel assembly 12 are mounted to pivot toward and away from the base of the kickboard 14. This facilitates a tilting action of the kickboard 14 on the transfer of weight of a rider of the scooter assembly 10 from one side of the kickboard 14 to the other.

The kickboard 14 includes a front flat portion 14a an a rear upward curved portion 14b. In use, the rider's front foot will be planted on the front or flat portion 14a of the kickboard 14, while the rider's rear foot will be planted on the upward curved rear portion 14b. As such, the rider will be provided with favourable manoeuvrability by transferring weight on the kickboard 14, and will also be provided with additional manoeuvrability, such as for example if the rider places additional weight on the rear foot. In this case, the front wheel assembly 11 may be lifted off the ground such that the scooter assembly 10 may pivot on the rear wheels 22 of the rear wheel assembly 12. Other manoeuvring effects will be readily appreciated by those in the art.

The kickboard 14 is rigidly fixed to a lower portion 13a of the frame 13. The lower portion 13a includes a pair of tubes, which are attached to the yoke 18 of the front wheel assembly 11 and which pass under the body of the kickboard 14 on either side of a central line of the kickboard. The frame 13. also includes a crossbar 13b which is also affixed to the yoke 18 of the front wheel assembly 11 and which is fixed, for example by welding, to the lower portion 13a of the frame 13, or is fixed to the kickboard 14. The upper portion 13b of the frame 13 generally follows the curvature of the front wheel 12 of the front wheel assembly 11. Additional support for the frame may also be provided under the kickboard 14.

The frame as a whole may be formed from any material conventionally used for scooters, bicycles or the like. In particular, the frame may be formed from steel, aluminium alloy, carbon fiber or other suitable materials as would be readily understood by those in the art. The material of construction may be selected depending on the envisaged use of the scooter assembly 10.

Although not depicted in the drawings, the scooter assembly 10 may also be provided with conventional accessories including mud guards, lights, a horn or bell, transport basket etc. Also, an auxiliary engine may be attached to the scooter assembly 10 to facilitate powered movement of the assembly 10.

Throughout this specification and the claims which follow, unless the context requires otherwise, the word “comprise”, and variations such as “comprises” and “comprising”, will be understood to imply the inclusion of a stated integer or group of integers or steps but not the exclusion of any other integer or group of integers or steps.

Those skilled in the art will appreciate that the invention described herein is susceptible to variations and modifications other than those specifically described. It is to be understood that the invention includes all such variations and modifications. The invention also includes all of the steps, features, compositions and compounds referred to or indicated in this specification, individually or collectively, and any and all combinations of any two or more of said steps or features.

1. A scooter assembly comprising:
a fame;
a kickboard mounted relative to said frame;
a front wheel assembly including a front wheel which is rotatably mounted relative to said frame to facilitate steering of the scooter assembly; and
a rear wheel assembly, wherein said rear wheel assembly comprises at least one pair of wheels which are mounted relative to said frame for pivotal movement in a lateral plane relative to the plane of said kickboard.

2. A scooter assembly according to claim 1, wherein the rear wheel assembly comprises a skateboard truck assembly including an axle housing which houses a hanger, yoke, base-plate and centre pivot, substantially the entirety of the skateboard truck assembly being located underneath the kickboard.

3. A scooter assembly according to claim 1, wherein the front wheel assembly comprises handlebars, a goose-neck and steering column which passes through a yoke, a pair of forks connected to the steering column and a front wheel mounted relative to the forks.

4. A scooter assembly according to claim 3, wherein the front wheel includes a spoked wheel and a pneumatic tyre.

5. A scooter assembly according to claim 1, wherein the frame includes a lower portion on which the kickboard is mounted, and optionally an upper curved portion which is rigidly fixed to the lower portion to provide stability to the assembly.

6. A scooter assembly according to claim 5, wherein the lower portion of the frame includes a single portion of tubing which passes centrally under the kickboard to which the kickboard is attached.

7. A scooter assembly according to claim 5, wherein the lower portion of the frame includes a pair of substantially parallel tubes which pass under the kickboard and are attached thereto and which are rigidly attached to a portion of the front wheel assembly.

8. A scooter assembly according to claim 1, wherein the kickboard is an oversized board including a flat front portion and an upwardly curved rear portion.
